(19) United States
(12) Patent Application Publication
(10) Pub. No.: US 2025/0219161 A1
(43) Pub. Date: Jul. 3, 2025

(54) SOLID-STATE SECONDARY BATTERY

(71) Applicant: HONDA MOTOR CO., LTD., Tokyo (JP)

(72) Inventors: Takashi NAKAGAWA, Saitama (JP); Hayato TAKAHASHI, Saitama (JP); Kyohei IZUMI, Saitama (JP)

(21) Appl. No.: 18/851,080

(22) PCT Filed: Mar. 22, 2023
(86) PCT No.: PCT/JP2023/011101

§ 371 Date: Sep. 26, 2024

(30) Foreign Application Priority Data
Mar. 30, 2022 (JP) 2022-055389

(51) Int. Cl. H01M 10/42; H01M 10/052

(52) U.S. Cl. CPC H01M 10/4235; H01M 10/052

(57) ABSTRACT

The present invention addresses the problem of providing a solid-state secondary battery capable of suppressing the uneven depositing of metal in a negative electrode interface in the solid-state secondary battery, and capable of improving cycling characteristics. The means for solving the problem is a solid-state secondary battery having a positive electrode layer, a negative electrode layer including at least a negative electrode current collector, a solid electrolyte layer containing a solid electrolyte material, and an intermediate layer provided between the negative electrode layer and the solid electrolyte layer. The voidage of the intermediate layer is greater than the voidage of the solid electrolyte layer.

### TECHNICAL FIELD

The present invention relates to a solid-state secondary battery.

### BACKGROUND ART

In recent years, research and development have been conducted on secondary batteries that contribute to energy efficiency in order to ensure that more people have access to affordable, reliable, sustainable, and advanced energy. Among secondary batteries, solid-state batteries are attracting attention because the batteries are excellent in that safety is improved because the solid electrolyte is non-flammable and that they have higher energy density.

In a solid-state battery, a metal such as lithium used as a charge transfer medium may be deposited between a solid electrolyte layer and a negative electrode layer by repeating charging and discharging. There is a concern that the electrical characteristics of the solid-state battery may deteriorate due to a decrease in the bonding property of the interface due to deposition of the metal. To address this issue, a technology is known in which a coating layer on which lithium metal can be deposited is provided to cover a negative electrode current collector, so that the lithium metal is deposited substantially uniformly on the surface of the coating layer, thereby making it difficult for dead lithium to be generated (for example, see Patent Document 1).

### CITATION LIST

### Patent Document

Patent Document 1: Japanese Unexamined Patent Application, Publication No. 2018-129159

### DISCLOSURE OF THE INVENTION

### Problems to be Solved by the Invention

Patent Document 1 discloses that the coating layer includes a metal capable of forming an alloy with lithium. On the other hand, since a change in volume of the solid-state battery occurs with charging and discharging, when the intermediate layer is formed of a material that does not easily follow the change in volume, there is a concern that the cycle characteristics may deteriorate due to a decrease in interfacial adhesion.

In response to the above issue, an object of the present invention is to provide a solid-state secondary battery capable of suppressing non-uniform deposition of a metal on a negative electrode interface of the solid-state secondary battery and improving cycle characteristics.

### Means for Solving the Problems

(1) The present invention relates to a solid-state secondary battery. The solid-state secondary battery includes a positive electrode layer, a negative electrode layer including at least a negative electrode current collector, a solid electrolyte layer including a solid electrolyte material, and an intermediate layer provided between the negative electrode layer and the solid electrolyte layer. The intermediate layer has a void ratio larger than a void ratio of the solid electrolyte layer.

According to the invention of (1), it is possible to provide a solid-state secondary battery capable of suppressing non-uniform deposition of metal on the negative electrode interface of the solid-state secondary battery and improving cycle characteristics.

(2) In the solid-state secondary battery according to (1), a particle diameter of particles constituting the intermediate layer is smaller than a particle diameter of particles of the solid electrolyte material.

According to the invention of (2), the adhesion between the solid electrolyte layer and the intermediate layer can be improved, and the contact area between the solid electrolyte layer and the intermediate layer can be increased.

(3) In the solid-state secondary battery according to (1) or (2), the void ratio of the intermediate layer is 40% to 70%.

According to the invention of (3), since it becomes easier for the charge transfer medium to pass through the intermediate layer and for the structure of the intermediate layer to be maintained, it is possible to make it difficult for the metal to deposit at the interface between the intermediate layer and the solid electrolyte layer.

(4) In the solid-state secondary battery according to any one of (1) to (3), the intermediate layer includes amorphous carbon.

According to the invention of (4), the electron conductivity of the intermediate layer can be ensured, and the particles constituting the intermediate layer and the charge transfer medium can be prevented from reacting with each other to form an alloy.

(5) In the solid-state secondary battery according to any one of (1) to (4), the intermediate layer includes a binding material.

According to the invention of (5), the adhesion between the particles constituting the intermediate layer and the adhesion between the intermediate layer and the solid electrolyte layer can be improved, making it easier to maintain the structure of the intermediate layer.

(6) In the solid-state secondary battery according to any one of (1) to (5), the intermediate layer includes metal nanoparticles, and a content of the metal nanoparticles in the intermediate layer is more than 0% by mass and 30% by mass or less.

According to the invention of (6), the volume expansion of the intermediate layer can be reduced, structural destruction of the intermediate layer and non-uniform deposition of the charge transfer medium can be suppressed, and the electron conductivity of the intermediate layer can be improved.

### BRIEF DESCRIPTION OF THE DRAWINGS

FIG. 1 is a schematic sectional view showing the structure of a solid-state secondary battery according to the present embodiment;

FIG. 2 is an enlarged view of a main part of FIG. 1, showing the structure of the solid-state secondary battery before charging and discharging;

FIG. 3 is an enlarged view of the main part of FIG. 1, showing the structure of the solid-state secondary battery after charging and discharging;

FIG. 4A is a micrograph of a main part of a solid-state secondary battery according to a Comparative Example;

FIG. 4B is a micrograph of the main part of the solid-state secondary battery according to the Comparative Example;

FIG. 5A is a micrograph of a main part of a solid-state secondary battery according to an Example;

FIG. 5B is a micrograph of the main part of the solid-state secondary battery according to the Example;

FIG. 6 is a graph showing the relationship between the number of cycles and the capacity retention rate of the solid-state secondary battery according to each of the Example and the Comparative Example; and

FIG. 7 is a graph showing the relationship between the number of cycles and the capacity retention rate of the solid-state secondary battery according to each of the Example and the Comparative Example.

### PREFERRED MODE FOR CARRYING OUT THE INVENTION

### <Solid-State Secondary Battery>

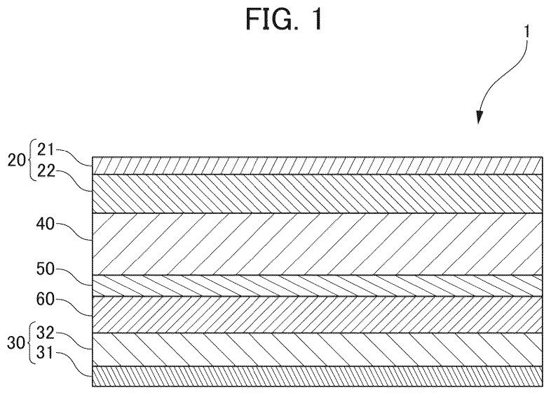

As schematically shown in FIG. 1, a solid-state secondary battery 1 according to the present embodiment is configured by laminating a positive electrode layer 20, a solid electrolyte layer 40, an intermediate layer 50, and a negative electrode layer 30 in this order. It should be noted that, since FIG. 1 schematically shows the configuration of the solid-state secondary battery 1 after charging and discharging, a metal deposition layer 60 is formed between the intermediate layer 50 and the negative electrode layer 30.

### (Positive Electrode Layer)

The positive electrode layer 20 includes a positive electrode current collector 21 and a positive electrode active material layer 22 containing at least a positive electrode active material.

The positive electrode current collector 21 is not limited as long as it has a function of collecting current of the positive electrode layer, and examples thereof include aluminum, an aluminum alloy, stainless steel, nickel, iron, and titanium, and among these, aluminum, an aluminum alloy, and stainless steel are preferred. Examples of the shape of the positive electrode current collector include a foil shape and a plate shape.

The positive electrode active material contained in the positive electrode active material layer 22 may be the same as that used in a positive electrode layer of a general solid-state battery, and is not limited. For example, in the case of a lithium ion battery, examples thereof include a layered active material containing lithium, a spinel active material, and an olivine active material. Specific examples of the positive electrode active material include lithium cobaltate (LiCoO₂), lithium nickelate (LiNiO₂), LiNiₚMn_{q}COᵣO₂ (p+q+r=1), LiNiₚAl_{q}CoᵣO₂ (p+q+r=1), lithium manganate (LiMn₂O₄), heterogenous element-substituted Li—Mn spinel represented by Li₁₊ₓMn_{2-x-y}M_{y}O₄ (x+y=2, M is at least one selected from Al, Mg, Co, Fe, Ni, or Zn), lithium titanate (an oxide containing Li and Ti), and lithium metal phosphate (LiMPO₄, M is at least one selected from Fe, Mn, Co, or Ni).

The positive electrode active material layer 22 may optionally contain a solid electrolyte from the viewpoint of improving the charge transfer medium conductivity. In addition, it may optionally contain a conductivity aid to improve electrical conductivity. Further, it may optionally contain a binder from the viewpoint of exhibiting flexibility. As the solid electrolyte, the conductivity aid, and the binder, those generally used in solid-state batteries can be used.

### (Negative Electrode Layer)

The negative electrode layer 30 includes a negative electrode current collector 31 and a negative electrode active material layer 32 containing at least a negative electrode active material.

The negative electrode current collector 31 is not limited as long as it has a function of collecting current of the negative electrode layer, and examples of the material of the negative electrode current collector include nickel, copper, and stainless steel. Examples of the shape of the negative electrode current collector include a foil shape and a plate shape.

As the negative electrode active material contained in the negative electrode active material layer 32, a known material capable of occluding and releasing a charge transfer medium such as lithium ions can be selected and used as appropriate. Examples thereof include lithium transition metal oxides such as lithium titanate, transition metal oxides such as TiO₂, Nb₂O₃, and WO₃, Si, SiO, metal sulfides, metal nitrides, carbon materials such as artificial graphite, natural graphite, graphite, soft carbon, and hard carbon, and metallic lithium, metal indium, and lithium alloys. The negative electrode active material is preferably metallic lithium. This is because the solid-state secondary battery 1 according to the present embodiment can preferably suppress the deposition of dendrites when metallic lithium is used as the negative electrode active material. The negative electrode active material may be in a powder form or a thin film form.

The negative electrode active material layer 32 may optionally contain a solid electrolyte from the viewpoint of improving the charge transfer medium conductivity. In addition, it may optionally contain a conductivity aid to improve electrical conductivity. Further, it may optionally contain a binder from the viewpoint of exhibiting flexibility. As the solid electrolyte, the conductivity aid, and the binder, those generally used in solid-state batteries can be used.

### (Solid Electrolyte Layer)

The solid electrolyte layer 40 is laminated between the positive electrode layer 20 and the negative electrode layer 30, and contains at least a solid electrolyte material. Charge transfer medium conduction can be performed between the positive electrode active material and the negative electrode active material through the solid electrolyte material contained in the solid electrolyte layer.

The solid electrolyte material is not limited as long as it has charge transfer medium conductivity, and examples thereof include a sulfide solid electrolyte material, an oxide solid electrolyte material, a nitride solid electrolyte material, and a halide solid electrolyte material.

Examples of the sulfide solid electrolyte material include Li₂S—P₂S₅ and Li₂S—P₂S₅—LiI in the case of a lithium ion battery. The “Li₂S—P₂S₅” means a sulfide solid electrolyte material including a raw material composition containing Li₂S and P₂S₅. The same applies to other similar descriptions.

Examples of the oxide solid electrolyte material include a NASICON type oxide, a garnet type oxide, and a perovskite type oxide in the case of a lithium ion battery. Examples of the NASICON type oxide include oxides containing Li, Al, Ti, P, and O (e.g., Li_{1.5}Al_{0.5}Ti_{1.5} (PO₄)₃). Examples of the garnet type oxide include oxides containing Li, La, Zr, and O (e.g., Li₂La₃Zr₂O₁₂). Examples of the perovskite type oxide include oxides containing Li, La, Ti, and O (e.g., LiLaTiO₃).

The void ratio of the solid electrolyte layer 40 is lower than the void ratio of the intermediate layer 50 described later, and is, for example, less than 10%. The particle diameter of the solid electrolyte material 41 constituting the solid electrolyte layer 40 is, for example, 0.5 to 10 μm in median diameter (D50), and is preferably larger than that of the particles constituting the intermediate layer described later.

The void ratio of the solid electrolyte 40 can be obtained, for example, by the following Equation (1). In Equation (1), the “filling ratio” means a percentage of the density of the solid electrolyte layer after molding with respect to the true density. Void ratio (%)=(100−filling ratio (%)) (1)

It should be noted that the method of calculating the void ratio is not limited to the above-described method, and the void ratio may be calculated by instrument analysis using BET, a porosimeter, gas diffusion, or the like, or image analysis using a scanning electron microscope or the like.

### (Intermediate Layer)

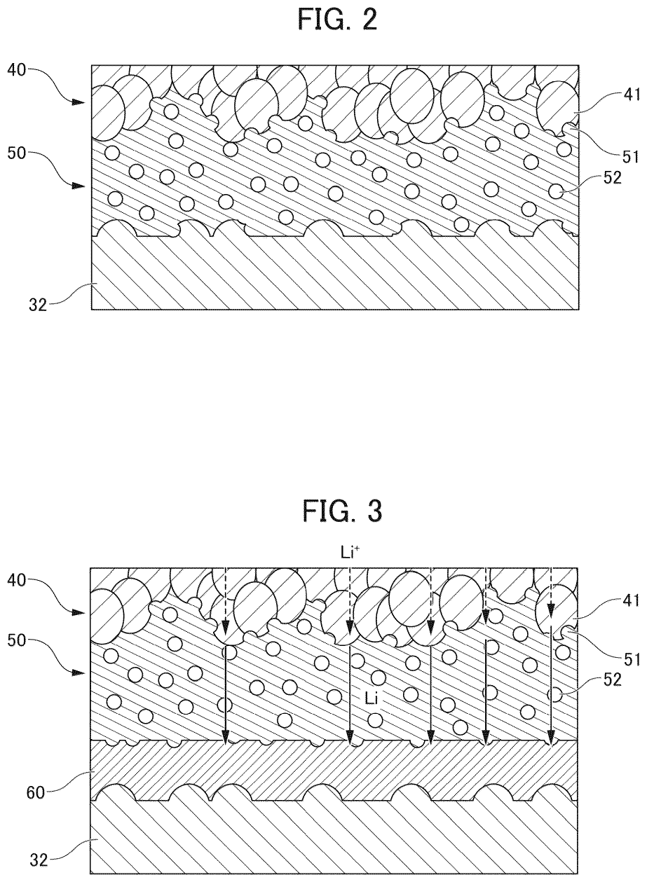

The intermediate layer 50 is laminated between the negative electrode layer 30 and the solid electrolyte layer 40. The intermediate layer 50 can suppress non-uniform deposition of metal on the interface of the negative electrode layer 30 and can improve interfacial adhesion. As shown in FIGS. 2 and 3, the intermediate layer 50 preferably includes amorphous carbon 51 and metal nanoparticles 52.

The function of the intermediate layer 50 will be described with reference to FIGS. 2 and 3. FIG. 2 is an enlarged view of a portion where the solid electrolyte layer 40, the intermediate layer 50, and the negative electrode layer 30 are laminated in FIG. 1, and is a schematic diagram showing the state immediately after fabrication of the solid-state secondary battery 1 before charging and discharging have been performed. FIG. 3 is a diagram corresponding to FIG. 2, and is a schematic diagram showing a state after the solid-state secondary battery 1 is repeatedly charged and discharged. In the following description, the charge transfer medium of the solid-state secondary battery 1 is assumed to be Li ions. In the case of a conventional solid-state secondary battery including no intermediate layer 50, metallic lithium is deposited at the interface between the solid electrolyte layer and the negative electrode layer as charging and discharging of the solid-state secondary battery are repeated. Once the metallic lithium is deposited, the electron conductivity of the portion increases, causing dendrites to form and metallic lithium to deposit non-uniformly. As a result, when charging and discharging are repeated, the negative electrode active material layer 32 becomes porous, and the interfacial adhesion is lowered, which may reduce the battery performance.

On the other hand, the intermediate layer 50 of the solid-state secondary battery 1 according to the present embodiment has electron conductivity and has voids through which Li ions can pass. Therefore, as shown in FIG. 3, as the solid-state secondary battery 1 is repeatedly charged and discharged, Li ions moving from the solid electrolyte layer 40 toward the negative electrode active material layer 32 pass through the intermediate layer 50, and the metal deposition layer 60 (layer of metallic lithium) is formed between the intermediate layer 50 and the negative electrode active material layer 32. This enables the metal deposition layer 60 to be uniformly formed. In addition, since the intermediate layer 50 has flexibility capable of following a change in volume of each layer accompanying charging and discharging, even when charging and discharging of the solid-state secondary battery 1 are repeated, the interfacial adhesion can be maintained, and the durability of the solid-state secondary battery 1 can be improved.

The void ratio of the intermediate layer 50 is higher than the void ratio of the solid electrolyte layer 40. This allows voids through which Li ions can pass to be formed inside the intermediate layer 50, and can make the intermediate layer 50 flexible and follow the volume change of the solid-state secondary battery 1. The void ratio of the intermediate layer 50 may be, for example, 40% to 70%. As a method of calculating the void ratio of the intermediate layer 50, the same method as the method of calculating the void ratio of the solid electrolyte 40 can be applied.

The intermediate layer 50 preferably includes the amorphous carbon 51. Unlike graphite or the like, for example, the amorphous carbon 51 does not react with lithium metal or the like to form an alloy, so that the formation of dendrites can be suppressed, and the cycle characteristics of the solid-state secondary battery 1 can be improved. Examples of the amorphous carbon 51 include carbon blacks such as acetylene black, furnace black, and Ketjen black, coke, and activated carbon. The amorphous carbon 51 may be graphitizable carbon (soft carbon), or may be non-graphitizable carbon (hard carbon), CNT (carbon nanotube), fullerene, or graphene.

The amorphous carbon as used herein is an allotrope of carbon that does not show a distinct crystalline state, and strictly speaking is not amorphous but is an aggregate of fine crystals of graphite. In other words, the amorphous carbon refers to an allotrope of carbon except diamond and graphite.

The intermediate layer 50 preferably includes the metal nanoparticles 52. Since the intermediate layer 50 includes the metal nanoparticles 52, the electron conductivity of the intermediate layer 50 can be increased, and the metal deposition layer 60 can be formed more uniformly. In addition, since the metal nanoparticles 52 have a higher Young's modulus than the amorphous carbon 51, the structure of the intermediate layer 50 can be maintained even when high-pressure pressing is performed during the manufacturing of the solid-state secondary battery 1. Examples of the metal nanoparticles 52 include metal nanoparticles of tin (Sn), silicon (Si), zinc (Zn), magnesium (Mg), gold (Au), platinum (Pt), palladium (Pd), silver (Ag), aluminum (Al), bismuth (Bi), and antimony (Sb). The content of the metal nanoparticles 52 is preferably more than 0% by mass and 30% by mass or less in the intermediate layer 50.

The particle diameter of particles such as the amorphous carbon 51 and the metal nanoparticles 52 that constitute the intermediate layer 50 is preferably smaller than the particle diameter of the solid electrolyte material 41. Accordingly, since the intermediate layer 50 can enter the gap between the solid electrolyte materials 41 constituting the interface of the solid electrolyte layer 40, the contact area between the solid electrolyte layer 40 and the intermediate layer 50 can be increased, and the adhesion therebetween can be improved. The particle diameter of the amorphous carbon 51 may be, for example, about 0.04 to 0.05 μm in median diameter (D50), and the particle diameter of the metal nanoparticles 52 may be, for example, about 0.07 μm in median diameter (D50).

To maintain the structure of the intermediate layer 50, the intermediate layer 50 preferably includes a binder as a binding material. As a result, the adhesion between the particles constituting the intermediate layer 50 and the adhesion between the intermediate layer 50 and the solid electrolyte layer 40 can be improved. The binder is not limited, and those generally used in solid-state batteries can be used. Examples thereof include PVDF polymers such as acrylic acid polymers, cellulose polymers, styrene polymers, vinyl acetate polymers, urethane polymers, and fluoroethylene polymers.

### <Solid-State Secondary Battery>

The solid-state secondary battery 1 according to the present embodiment is manufactured by laminating the positive electrode layer 20, the solid electrolyte layer 40, the intermediate layer 50, and the negative electrode layer 30 in the order shown in FIG. 1. After the lamination, they may be optionally pressed to be integrated. Furthermore, the constituent unit shown in FIG. 1 may be used as a unit cell, and a plurality of the constituent units may be stacked.

Although the preferred embodiment of the present invention has been described above, the present invention is not limited to the above embodiment, and modifications and improvements within a range capable of achieving the object of the present invention are included in the present invention.

### EXAMPLES

The present invention will now be described in detail using examples. However, the present invention is not limited to these examples.

### Example 1

### [Preparation of Solid Electrolyte Layer]

An argyrodite-type sulfide solid electrolyte was used as the solid electrolyte material.

### [Preparation of Positive Electrode Layer]

A slurry was prepared by using a lithium nickel cobalt manganese composite oxide (NCM622) as a positive electrode active material, an argyrodite-type sulfide solid electrolyte as a solid electrolyte, butyl butyrate as a solvent, carbon black as a conductivity aid, and an SBR (styrene butadiene rubber)-based binder as a binding material, and the slurry was coated on an aluminum foil as a positive electrode current collector and dried to prepare a positive electrode layer.

### [Preparation of Negative Electrode Layer]

Metallic lithium was used as a negative electrode active material and bonded to a SUS foil as an electrode current collector to prepare a negative electrode layer.

### [Preparation of Intermediate Layer]

A slurry was prepared by using Sn as metal nanoparticles, acetylene black (particle diameter: 0.05 μm) as amorphous carbon, NMP (N-methyl-2-pyrrolidone) as a solvent, and a PVDF-based binder as a binding material, and the slurry was coated and dried to prepare an intermediate layer.

### [Production of Solid-State Secondary Battery]

The positive electrode layer, the solid electrolyte layer, the intermediate layer, and the negative electrode layer obtained as described above were laminated in this order and pressed to produce a solid-state secondary battery according to Example 1. The void ratio of the intermediate layer after the production was 418. The void ratio of the intermediate layer was determined by the following Equation (2). In Equation (2), the “filling ratio” means a percentage of the density of the intermediate layer after molding with respect to the true density. Void ratio (%)=(100−filling ratio (%)) (2)

### Examples 2 to 10 and Comparative Examples 1 to 3

Solid-state secondary batteries according to other Examples and Comparative Examples were produced in the same manner as in Example 1 except that the intermediate layer and the solid electrolyte layer were configured as shown in Tables 1 and 2. In Comparative Example 1, no intermediate layer was formed.

TABLE 1

| | | | | | | Solid Electrolyte | | Evaluation of Battery Characteristics | | |
|---|---|---|---|---|---|---|---|---|---|---|
| | | | | | | Layer | | | Average | |
| | Intermediate Layer | | | | | Particle | | Discharge | charging and | |
| | Particle | | Particle | Mass | | diameter | | capacity | discharging | |
| | diameter of | | diameter | ratio of | | of solid | | retention | efficiency | Passage of |
| | amorphous | Type of | of metal | metal | Void | electrolyte | Void | rate after | over 1 to | Li through |
| | carbon | metal | particles | particles | ratio | material | ratio | cycle test | 50 cycles | intermediate |
| | (μm) | particles | (μm) | (%) | (%) | (μm) | (%) | (%) | (%) | layer |
| Example 1 | 0.05 | Sn | 0.07 | 23.8 | 41 | 3 | 2 | 98.8 | 99.89 | 2 |
| Example 2 | 0.05 | Sn | 0.07 | 23.8 | 41 | 3 | 2 | 97.3 | 99.82 | 2 |
| Example 3 | 0.05 | — | — | — | 43 | 3 | 2 | 97.0 | 99.86 | 2 |
| Example 4 | 0.05 | Sn | 0.07 | 23.8 | 63 | 3 | 2 | 93.9 | 99.80 | 2 |
| Example 5 | 0.05 | Sn | 0.07 | 30.0 | 56 | 3 | 2 | 91.9 | 99.76 | 2 |
| Example 6 | 0.05 | Sn | 0.07 | 23.8 | 41 | 0.6 | 2 | 97.2 | 99.84 | 2 |
| Example 7 | 0.05 | Sn | 0.07 | 23.8 | 41 | 1.3 | 2 | 98.1 | 99.87 | 2 |
| Example 8 | 0.04 | Sn | 0.07 | 32.0 | 56 | 3 | 2 | 86.4 | 99.09 | 2 |
| Example 9 | 0.04 | Sn | 0.07 | 38.0 | 52 | 3 | 2 | 86.0 | 99.06 | 2 |
| Example 10 | 0.04 | Sn | 0.07 | 47.5 | 42 | 3 | 2 | 83.3 | 98.83 | 2 |

TABLE 2

| | | | | | | | | Evaluation of Battery Characteristics | | |
|---|---|---|---|---|---|---|---|---|---|---|
| | | | | | | Solid Electrolyte Layer | | | Average | |
| | Intermediate Layer | | | | | Particle | | Discharge | charging and | |
| | Particle | | Particle | Mass | | diameter | | capacity | discharging | |
| | diameter of | | diameter | ratio of | | of solid | | retention | efficiency | Passage of |
| | amorphous | Type of | of metal | metal | Void | electrolyte | Void | rate after | over 1 to | Li through |
| | carbon | metal | particles | particles | ratio | material | ratio | cycle test | 50 cycles | intermediate |
| | (μm) | particles | (μm) | (%) | (%) | (μm) | (%) | (%) | (%) | layer |
| Comparative | — | — | — | — | — | 3 | 2 | 68.8 | 97.84 | — |
| Example 1 | | | | | | | | | | |
| Comparative | 0.05 | Sn | 0.07 | 23.8 | 41 | 3 | 50 | 30.2 | 95.07 | 1 |
| Example 2 | | | | | | | | | | |
| Comparative | 0.05 | Sn | 0.07 | 23.8 | 41 | 3 | 45 | 44.3 | 96.25 | 1 |
| Example 3 | | | | | | | | | | |

### [Sectional Observation]

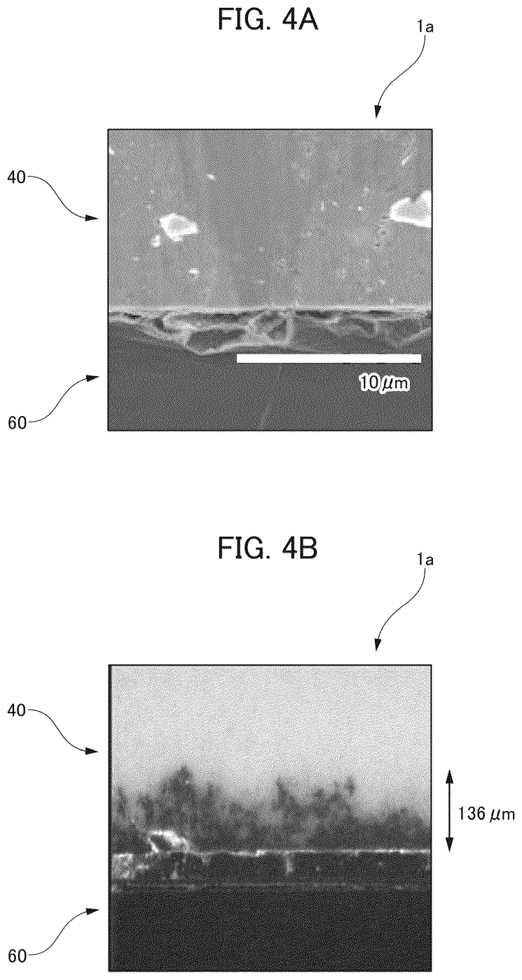

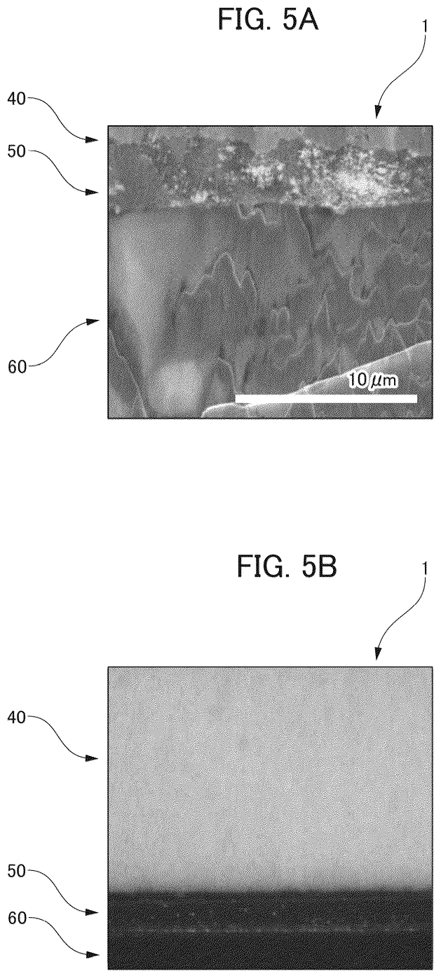

The solid-state secondary batteries according to Example 1 and Comparative Example 1 were charged and discharged for 20 cycles at a C rate of ⅓C. and 25° C., and subsequently the vicinity of the interface of the negative electrode layer or the solid electrolyte layer was observed with a field emission scanning electron microscope (FE-SEM): S-4300SE (manufactured by Hitachi High-Tech Corporation) (FIGS. 4A and 5A) and an optical microscope (FIGS. 4B and 5B). The results of Comparative Example 1 are shown in FIGS. 4A and 4B, and the results of Example 1 are shown in FIGS. 5A and 5B.

As shown in FIGS. 4A and 4B, in a solid-state secondary battery 1a according to Comparative Example 1, it was observed that the metal deposition layer 60 was formed at the interface between the solid electrolyte layer 40 and the negative electrode layer, and the metal deposition layer 60 was porous. On the other hand, as shown in FIGS. 5A and 5B, in the solid-state secondary battery 1 according to Example 1, it was observed that the metal deposition layer 60 was formed at the interface between the intermediate layer 50 and the negative electrode layer, and the metal deposition layer 60 was not porous.

### [Capacity Retention Rate Measurement]

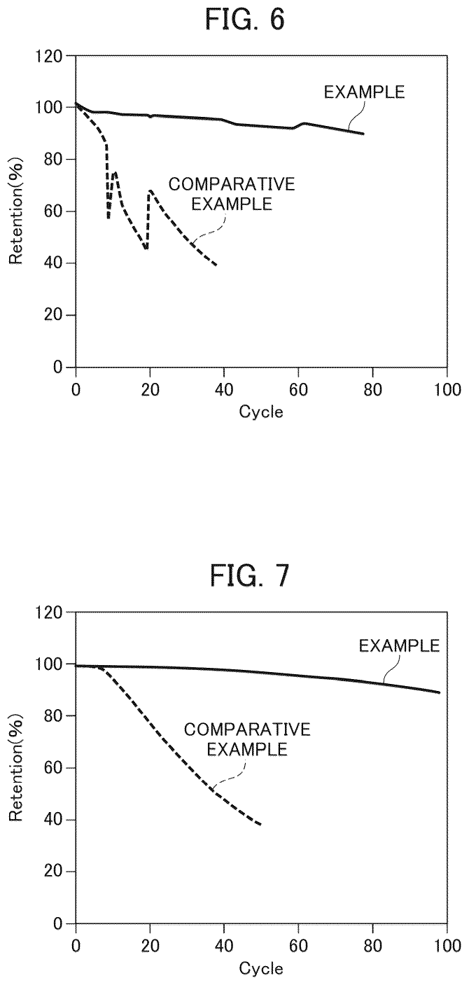

The solid-state secondary batteries according to Example 1 and Comparative Example 1 were each subjected to a cycle test in which charging and discharging were repeated at a charge upper limit voltage of 4.3 V, a discharge lower limit voltage of 2.65 V, and a C rate of ⅓ C., and the capacity retention rate was measured. FIG. 6 shows the test results at 25° C., and FIG. 7 shows the test results at 45° C. In the graphs of FIGS. 6 and 7, the vertical axis represents the capacity retention rate (%), and the horizontal axis represents the number of cycles (times).

As shown in FIGS. 6 and 7, the solid-state secondary battery according to Example 1 exhibited a more gradual decrease in the capacity retention rate with an increase in the number of cycles compared to the solid-state secondary battery according to Comparative Example 1, and favorable cycle characteristics were obtained.

### [Evaluation of Battery Characteristics]

The solid-state secondary batteries according to the Examples and Comparative Examples were each charged and discharged for 50 cycles at a C rate of ⅓ C. and 45° C., and the discharge capacity retention rate (%) at a C rate of 1/10 C. and 25° C. after the cycle test, the average charging and discharging efficiency (%) over 1 to 50 cycles, and passage of Li through the intermediate layer were evaluated. The passage of Li through the intermediate layer was evaluated according to the following criteria. The results are shown in Tables 1 and 2.

### (Evaluation Criteria for Passage of Li Through Intermediate Layer)

An evaluation score of 2 indicates that a metal deposition layer is formed between the intermediate layer and the negative electrode layer. An evaluation score of 1 indicates that no metal deposition layer is formed between the intermediate layer and the negative electrode layer, or a metal deposition layer is formed in the solid electrolyte layer or between the intermediate layer and the solid electrolyte layer.

From the results of Tables 1 and 2, it is clear that in the solid-state secondary battery according to each Example, a metal deposition layer is formed between the intermediate layer and the negative electrode layer. In addition, it is clear that in the solid-state secondary battery according to each Example, the discharge capacity retention rate (%) after the cycle test and the average charging and discharging efficiency (%) over 1 to 50 cycles are higher than those of the solid-state secondary battery according to each Comparative Example, and favorable cycle characteristics can be obtained.

### EXPLANATION OF REFERENCE NUMERALS

1 solid-state secondary battery
20 positive electrode layer
30 negative electrode layer
31 negative electrode current collector
40 solid electrolyte layer
41 solid electrolyte material
50 intermediate layer
51 amorphous carbon
52 metal nanoparticles

1. A solid-state secondary battery, comprising:
a positive electrode layer;
a negative electrode layer comprising at least a negative electrode current collector;
a solid electrolyte layer comprising a solid electrolyte material; and
an intermediate layer provided between the negative electrode layer and the solid electrolyte layer,
wherein the intermediate layer comprises metal nanoparticles, and
the intermediate layer has a void ratio larger than a void ratio of the solid electrolyte layer.

2. The solid-state secondary battery according to claim 1, wherein a particle diameter of particles constituting the intermediate layer is smaller than a particle diameter of particles of the solid electrolyte material.

3. The solid-state secondary battery according to claim 1, wherein the void ratio of the intermediate layer is 40% to 70%.

4. The solid-state secondary battery according to claim 1, wherein the intermediate layer comprises amorphous carbon.

5. The solid-state secondary battery according to claim 1, wherein the intermediate layer comprises a binding material.

6. The solid-state secondary battery according to claim 1, wherein a content of the metal nanoparticles in the intermediate layer is more than 0% by mass and 30% by mass or less.
